(19) United States
(12) Patent Application Publication
(10) Pub. No.: US 2009/0097179 A1
(43) Pub. Date: Apr. 16, 2009

(54) Over current protection method for a power supply and apparatus thereof

(75) Inventor: Chih-Ming Chen, Pingtung City (TW)

Correspondence Address: BACON & THOMAS, PLLC, 625 SLATERS LANE, FOURTH FLOOR, ALEXANDRIA, VA, 22314-1176, US

(73) Assignee: SINPRO ELECTRONICS CO., LTD., Pingtung City (TW)

(21) Appl. No.: 11/907,311

(22) Filed: Oct. 11, 2007

(51) Int. Cl. H02H 3/08

(52) U.S. Cl. 361/87

(57) ABSTRACT

An over current protection method for a power supply includes steps as follows. Firstly, an output current value of the power supply is received. Secondly, whether the power supply has an over current status is determined in accordance with the received output current value. Thirdly, if the over current status occurs, the over current status is monitored to check whether the over current status continues for more than a setting period of time. If the over current status continues for more than the setting period of time, the power supply is disabled. On the other hand, if the over current status is eliminated with the setting period of time, a process flow returns to the first step of receiving an output current value of the power supply.

### BACKGROUND OF THE INVENTION

1. Field of the Invention

The invention relates in general to an over current protection method for a power supply and apparatus thereof, and more particularly to a method to detect an over current status of a power supply and apparatus thereof.

2. Description of the Related Art

Limited Power Sources (LPS) regulation is set by safety administration to provide a safety standard for a load to avoid an over current that may cause a fire accident. When a power supply apparatus passes the LPS safety regulation's test, the power supply apparatus is allowed to use inferior fireproofing material.

In order to pass the LPS safety regulation's test, the conventional measurements are as follows.

Firstly, a fuse is used as over current protection. With reference to FIG. 6, a fuse 71 is coupled to an output terminal of a power supply 70. When an output current of the power supply 70 is larger than a standard short current of the LPS safety regulation, the fuse 71 must melt within one minute to secure. Although this method can achieve the objective to protect the over current, once the fuse 71 melts, the fuse 71 can not recover automatically. Hence the power supply is unable to work until the fuse 71 is replaced.

Secondly, a constant current protection method is used. This method is to set a constant value as the maximum output current of the power supply. With reference to FIG. 7, a constant current circuit 80 is coupled to a power supply 70. The constant current circuit 80 checks an output current of the power supply 70 and determine whether the output current is larger than a setting constant current value. If determining result is positive, the constant current circuit 80 disables the power supply 70. In this way, the output current of the power supply 70 is limited to the constant value, so that the power supply 70 is not suitable to be used for an electronic device with variable large loads.

### SUMMARY OF THE INVENTION

An objective of the present invention is to provide an over current protection method for a power supply and apparatus thereof. The present invention is aimed to effectively overcome the disadvantages of the conventional over current protection measurements that the fuse can not auto-recover and the power supply can not provide the larger current than the setting constant value.

In order to achieve the above objective, the over current protection method for a power supply and apparatus thereof is provided. The over current protection method includes multiple steps as follows.

Firstly, an output current value of the power supply is received. Secondly, whether the power supply has an over current status is determined in accordance with the received output current value. Thirdly, if the over current status occurs, the over current status is monitored to check whether the over current status continues for more than a setting period of time. If the over current status continues for more than the setting period of time, the power supply is disabled. On the other hand, if the over current status is eliminated with the setting period of time, a process flow returns to the first step of receiving an output current value of the power supply.

### BRIEF DESCRIPTION OF THE DRAWINGS

FIG. 1 is a block diagram of an over current protection apparatus coupled to a power loop;

FIG. 2 is a flow diagram of an over current protection method in accordance with the present invention;

FIG. 3 is a current curve diagram of a power supply;

FIGS. 4A to 4C are parts of a detailed circuit diagram of the over current protection apparatus in accordance the present invention;

FIG. 5 is a detailed circuit diagram of a control unit in accordance with the present invention;

FIG. 6 is a block diagram of a first conventional over current protection device coupled to a power loop; and

FIG. 7 is a block diagram of a second conventional over current protection device coupled to the power loop in accordance with the prior art.

### DETAILED DESCRIPTION OF THE INVENTION

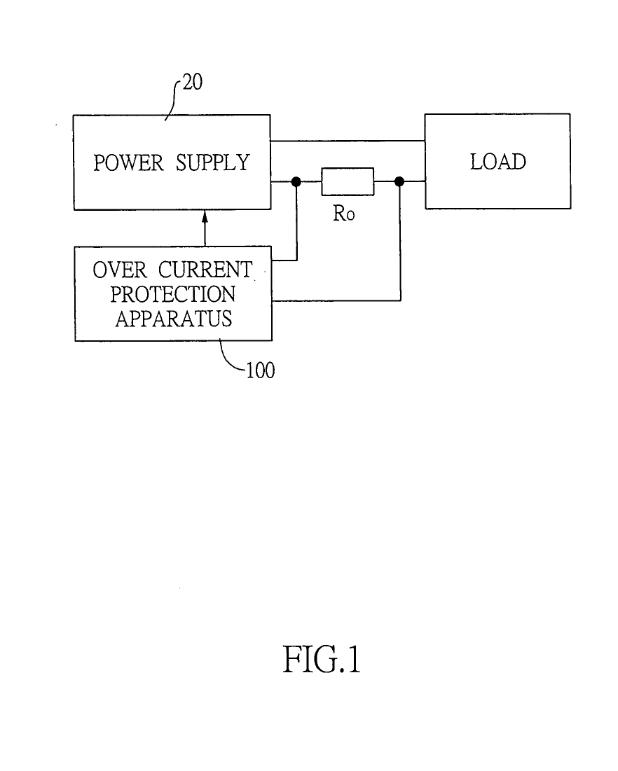

With reference to FIG. 1, a power supply 20 is connected to a load to establish a power loop. An over current protection apparatus 100 is coupled to the power loop to detect a present output current of the power supply 20 and executes an over current protection method in accordance with the present invention. Further, the over current protection apparatus 100 presets a standard value and a target time, and is connected to the power supply 20

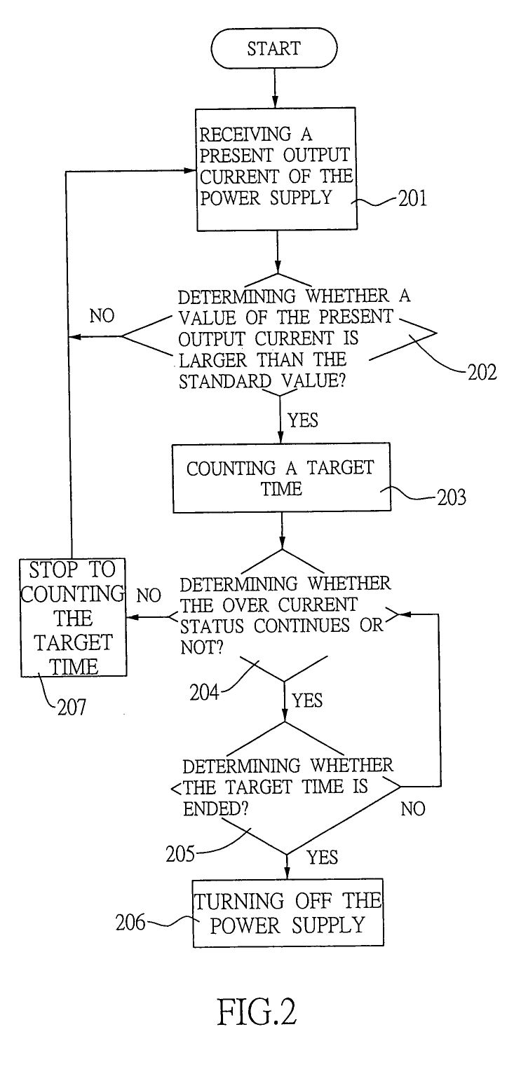

With reference to FIG. 2, the over current protection method has following steps of:

(a) receiving a present output current of the power supply to obtain the value of the present output current 201;

(b) determining whether the value of the present output current is larger than standard value 202, wherein if a determining result is negative, return to step (a), and if the determining result is positive an over current status is existed;

(c) counting the target time 203;

(d) receiving a present output current of the power supply to compare with the standard value to re-determine the over current status is still existed 204; wherein if a determining result is negative, stop counting 207 and return to the step (a) and if the determining result is positive, the over current status is continuously existed;

(e) determining whether the target time is ended 205, wherein if a determining result is negative, go to the step (d) and if the determining result is positive, turn off the power supply 206.

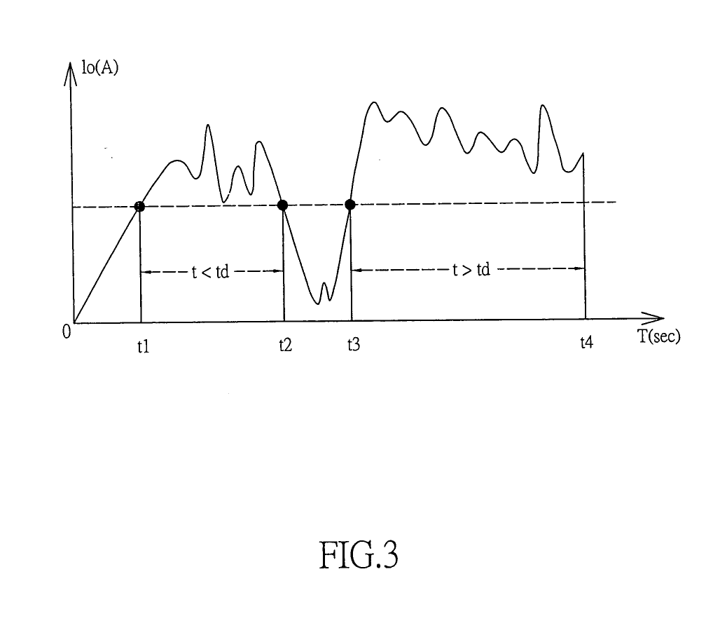

The aforesaid working operation principle in accordance with the present invention can be illustrated as a characteristic curve figure in FIG. 3. When the power supply works, an output current lo is undulated that may be higher than the standard value of a dotted line along a transverse axle. Once the output current Io is larger than the standard value, which occurs the over current status, the target time (td) is started to count. If the over current status continues for a period of time t which is shorter than the target time (td), the counting step is stopped. On the contrary, if the over current status continues for a period of time t which is longer than the target time td, the power supply is turned off. With the aforesaid power on delay design, the large number of current value can be supplied to a variable load and also the LPS safety requirement can be met.

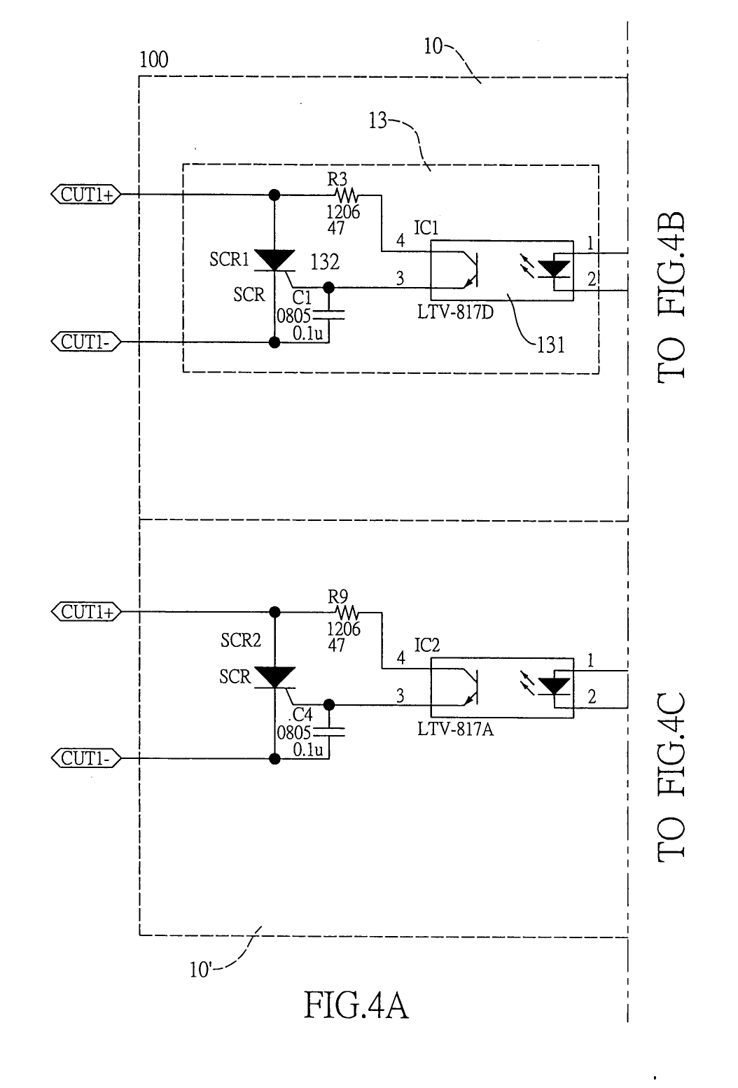

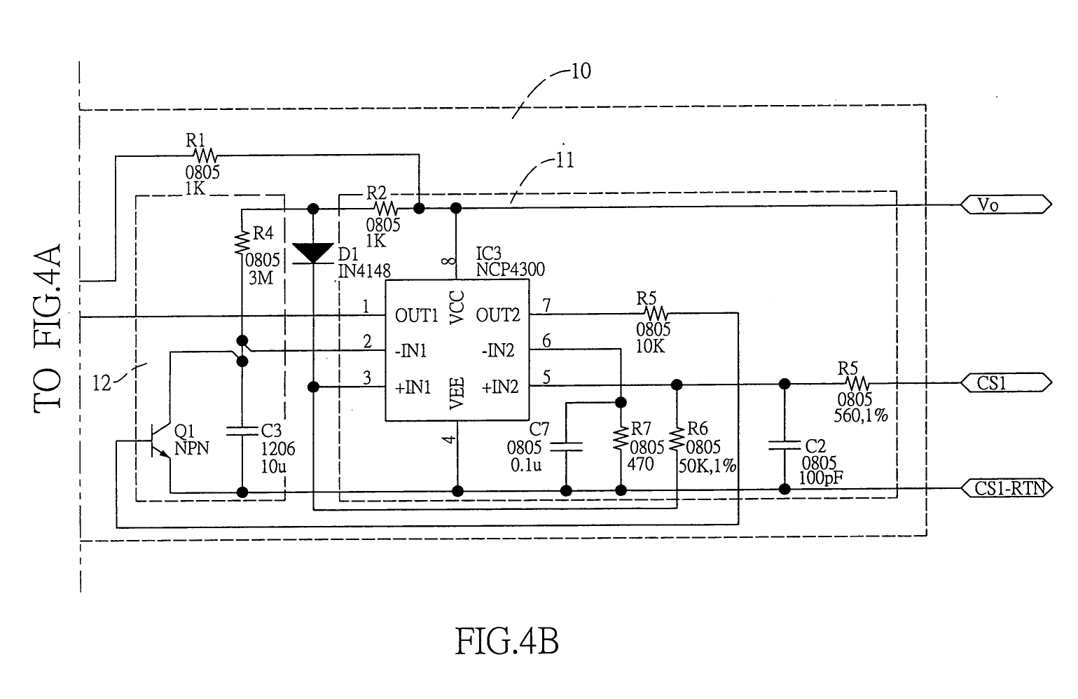

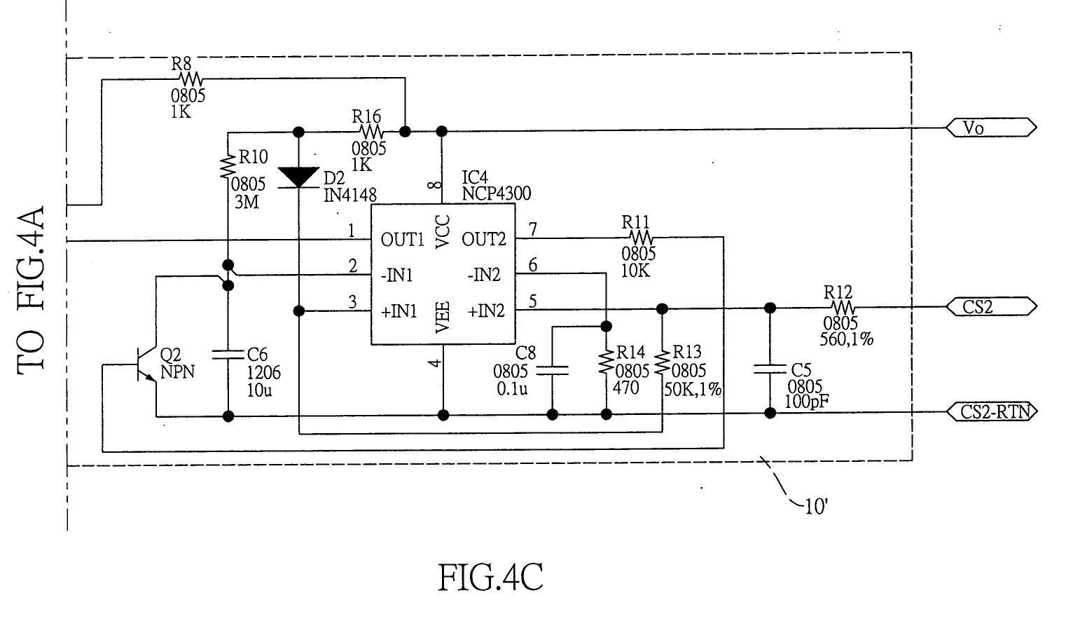

With reference to FIGS. 4A to 4C, a detailed circuit diagram of a preferred embodiment of an over current protection apparatus 100 in accordance with the present invention is shown. The over current protection apparatus 100 has a first over current protection circuit 10 and a second over current protection circuit 10′. A structure and an operation method of the two over current protection circuits 10 and 10′ are exactly the same. The purpose to prepare two identical over current protection circuits 10 and 10′ is to make the first over current protection circuit 10 works normally and the second over current protection circuits 10′ works as a backup circuit. If the first over current protection circuits 10 is out of order, the second over current protection circuits 10′ can replace the first over current protection circuits 10 to provide a protection measurement. Since the two over current protection circuits 10 and 10′ are identical, the following description takes the first over current protection circuit 10 as the example to illustrate.

The first over current protection circuit 10 has a control unit 11, a delay unit 12 and a turning off signal generator 13.

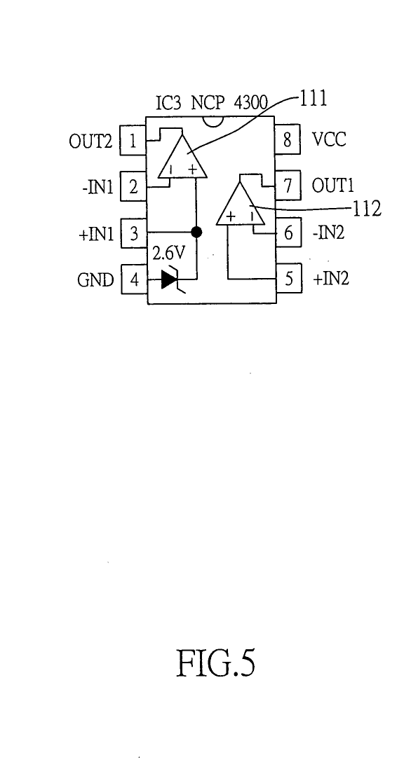

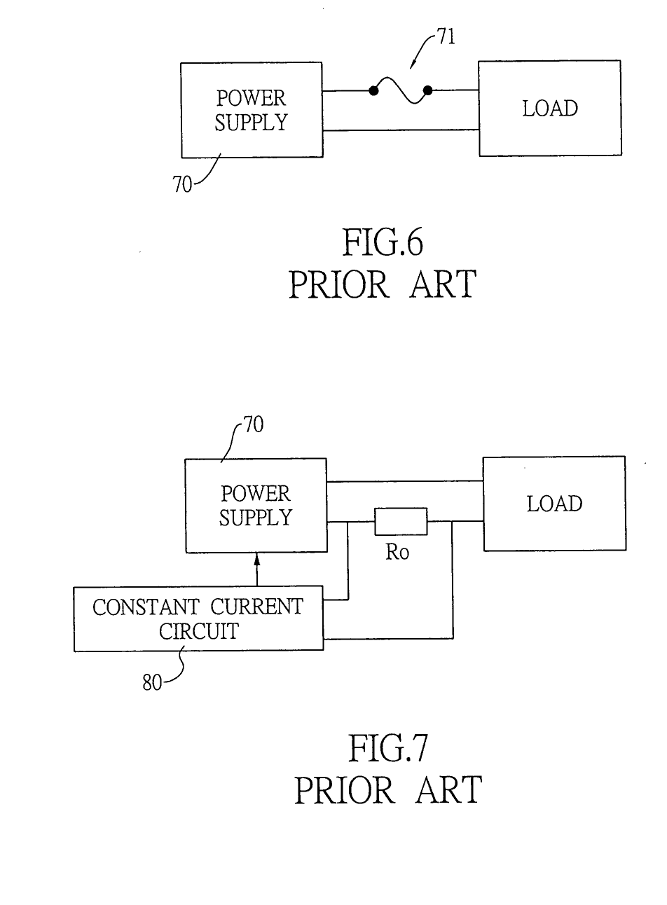

In this preferred embodiment, the control unit 11 is made up by a number NCP 4300 controller IC3 together with other peripheral components. With reference to FIG. 5, an internal part of the controller IC3 has two OP amplifiers, which is defined as a first comparator 111 and a second comparator 112 in accordance with the present invention. A positive input terminal +IN2 of the second comparator 112 forms an output current detection terminal CS1 for coupling with an output terminal of a power supply via an output resistor (not shown in the diagram), so as to receive an output current value of the power supply. The positive input terminal +IN2 compares the received current with a reference electric potential of a negative terminal −IN2. In accordance with a comparison result, the electric potential of an output signal of the second comparator 112 is determined. A negative terminal −IN1 of the first comparator 111 is coupled with an output terminal of the delay unit 12 for determining whether the electric potential of an output signal of the delay unit 12 is larger than the electric potential of a positive terminal +IN1. In accordance with a comparison result, the electric potential of an output signal of the first comparator 111 is determined.

The delay unit 12 includes a transistor Q1 and a charging and discharging circuit. The charging and discharging circuit is made up by a resistor R4 and a capacitor C3, which are series-connected between a power source VO and the ground terminal. Fully charged time T is determined by a resistance of the resistor R4 and a capacitance of the capacitor C3. The resistor R4 and the capacitor C3 are coupled to the negative terminal −IN1 of the first comparator 111 of the control unit 11 by a serial-connected node. Moreover, in this preferred embodiment, the transistor Q1 is an NPN transistor. Abase of the NPN transistor is coupled to the output terminal of the second comparator 112 of the control unit 11, so as to be a control terminal. A collector and an emitter of the transistor Q1 are cross-coupled on two terminals of the capacitor C3. In other words, when the transistor Q1 is cutoff, the capacitor C3 is charged via the resistor R4. When the capacitor C3 is charged for a period of time, the capacitor C3 is fully charged and generates an electric potential on the negative terminal −IN1 larger than the positive terminal +IN1 of the first comparator 111. Hence the first comparator 111 outputs a low electric potential. On the contrary, when the capacitor C3 is charged, if the transistor Q1 is conductive, the two terminals of the capacitor C3 is short and the capacitor C3 stops to be charged. At this moment, the first comparator 111 outputs a high electric potential.

The turning off signal generator 13 has an optical isolator 131 and an electric switch 132. The electric switch 132 is made up by a silicon controlled rectifier SCR. A gate of the silicon controlled rectifier SCR is coupled with an output terminal of the optical isolator 131. A positive pole and a negative pole of the silicon controlled rectifier SCR are used for coupling with the power supply to provide a turning off signal. An input terminal of the optical isolator 131 is coupled to the output terminal of the first comparator 111 of the control unit 11 for determining whether the turning off signal generator 13 should send out the turning off signal or not in accordance with the output electric potential of the first comparator 111.

The detailed circuit structure of the preferred embodiment in accordance with the present invention can be clearly understood from the above description. With reference to FIGS. 4A to 4C, an operation method of the present invention for a power supply is further illustrated as follows. When a power supply (not shown in the diagram) outputs current normally, the second comparator 112 of the control unit 11 outputs a high electric potential to make the transistor Q1 of the delay unit 12 conductive. At this moment, the capacitor C3 is short and not charged. When the power supply outputs the current larger than the setting value, the second comparator 112 outputs a low electric potential to make the transistor Q1 of the delay unit 12 cut-off. At this moment, the capacitor C3 starts to be charged and also achieves fully charged within a setting charged time in accordance with the resistance of the resistor R4 and the capacitance of the capacitor C3. In this preferred embodiment, the setting charged time is of 45 seconds. The setting charged time also provides delay buffer duration. During the delay buffer duration, if the power supply outputs the current that is lower than the setting value, the transistor Q1 is conductive again and the turning off signal generator 13 is not enabled. At this moment, the power supply still operates normally.

On the other hand, if the output current of the power supply continues to be larger than the setting value until the capacitor C3 is fully charged, the output terminal of the first comparator 111 of the control unit 11 outputs the low electric potential and the turning off signal generator 13 is enabled. Then the electric switch 132 provides a disconnection action to the power supply to disable the power supply, so as to achieve the objective of the over current protection.

It can be clearly understood from the above circuit design that the over current protection apparatus in accordance with the present invention allows the power supply to output the undulated current. With the over current protection method and apparatus thereof in accordance with the present invention, even when the power supply outputs the current larger than the setting value, the power supply will not be disabled immediately. With the delay buffer duration, the large number of current can be acquired and also the LPS safety requirement can be met, which is very useful for large tools.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An over current protection method for a power supply comprising steps of:
(a) presetting a standard value and a target time;
(b) receiving a present output current of the power supply to obtain the value of the present output current;
(c) determining whether the value of the present output current is larger than standard value, wherein if a determining result is negative, return to step (b), and if the determining result is positive an over current status is existed; and
(d) determining whether the over current status is continuously existed for the target time, wherein if a determining result is positive, turning off a power supply, and if the determining result is negative, go to the step (b).

2. The method as claimed in claim 1, wherein the step (d) comprises acts of:
(d1) receiving a present output current of the power supply to compare with the standard value to re-determine the over current status is still existed; wherein if a determining result is negative, stop counting and return to the step (b) and if the determining result is positive, the over current status is continuously existed; and
(d2) determining whether the target time is ended, wherein if a determining result is negative, go to the step (d1) and if the determining result is positive, turn off the power supply.

3. An over current protection apparatus for a power supply comprising at least an over current protection circuit, each of which comprises:
a turning off signal generator generating a turning off signal;
a control unit comprising
a first comparator having output terminal coupled to the turning off signal generator; and
a second comparator connected to a reference signal and an output terminal of a power supply and comparing whether an output current of the power supply is larger than the reference signal;
a delay unit comprising a transistor and a charging and discharging circuit, wherein the charging and discharging circuit is made up by a resistor and a capacitor, which are series-connected between a power source VO and the ground terminal, wherein a resistance of the resistor and a capacitance of the capacitor determine fully charged time, wherein the resistor and the capacitor are coupled to the first comparator of the control unit by a serial-connected node, wherein a base of the transistor forms a control terminal coupled to an output terminal of the second comparator of the control unit, wherein a collector and an emitter of the transistor are cross-coupled on two terminals of the capacitor.

4. The over current protection apparatus for a power supply as claimed in claim 3, wherein the turning off signal generator comprises an optical isolator and an electric switch, wherein an input terminal of the optical isolator is coupled to the output terminal of the first comparator of the control unit, wherein an output terminal of the optical isolator is coupled to the electric switch, wherein the electric switch provides a close action to the power supply.

5. The over current protection apparatus for a power supply as claimed in claim 4, wherein the electric switch is made up by a silicon controlled rectifier, wherein a gate of the silicon controlled rectifier is coupled with an output terminal of the optical isolator.

6. The over current protection apparatus for a power supply as claimed in claim 3 comprising two over current protection circuits.

7. The over current protection apparatus for a power supply as claimed in claim 4 comprising two over current protection circuits.

8. The over current protection apparatus for a power supply as claimed in claim 5 comprising two over current protection circuits.
